(19) United States
(12) Patent Application Publication
(10) Pub. No.: US 2009/0279127 A1
(43) Pub. Date: Nov. 12, 2009

(54) Mechanism for data extraction of variable positioned data

(75) Inventors: Kumar V. Kadiyala, Boulder, CO (US); Craig D. Brossman, Durango, CO (US)

Correspondence Address: InfoPrint Solutions/ Blakely, 1279 Oakmead Parkway, Sunnyvale, CA, 94085-4040, US

(73) Assignee: InfoPrint Solutions Company LLC

(21) Appl. No.: 12/151,832

(22) Filed: May 8, 2008

(51) Int. Cl. G06K 15/00

(52) U.S. Cl. 358/1.15

(57) ABSTRACT

A method is disclosed. The method includes generating one or more Tag Logical Elements (TLEs) in a variable location within a page of an Advanced Function Presentation (AFP) document.

### FIELD OF THE INVENTION

This invention relates generally to the field of printing systems. More particularly, the invention relates to identifying resources prior to printing.

### BACKGROUND

Print systems include presentation architectures that are provided for representing documents in a data format that is independent of the methods that are utilized to capture or create those documents. One example of an exemplary presentation system, which will be described herein, is the (Advanced Function Presentation) AFP™ system developed by International Business Machines Corporation. According to the AFP system, documents may include combinations of text, image, graphics, and/or bar code objects in device and resolution independent formats. Documents may also include and/or reference fonts, overlays, and other resource objects, which are required at presentation time to present the data properly.

Additionally, documents may also include resource objects, such as a document index and tagging elements supporting the search and navigation of document data for a variety of application purposes. In general, a presentation architecture for presenting documents in printed format employs a presentation data stream. To increase flexibility, this stream can be further divided into a device-independent application data stream and a device-dependent printer data stream. A data stream is a continuous ordered stream of data elements and objects that conform to a given formal definition. Application programs can generate data streams destined for a presentation device, archive library, or another application program.

Further, the AFP architecture provides Tag Logical Element (TLE) structured fields for content-based tagging. The indexing information in the TLEs applies to the page or page group containing them. TLEs are effective if the content of the variable data is predictable, for example, if a zip code of an address is always located on the same line of the data. However, TLEs do not work effectively if the location of the data is not always the same. For instance, the zip code portion of an address block is typically in the last line of the address block, which may have a variable number of lines.

Currently there are two mechanisms for defining such a TLE. The first method includes looking on n entire page for data. The second method comprises defining the position of the data with a threshold around which the data may be located. Each of these mechanisms is unreliable.

### SUMMARY

In one embodiment, a method is disclosed. The method includes generating one or more Tag Logical Elements (TLEs) in a variable location within a page of an Advanced Function Presentation (AFP) document. In another embodiment, a printing system is disclosed. The printing system includes a print application to enable a user generate one or more TLEs in a variable location within a page of an AFP document. In yet another embodiment, the print application included a graphical user interface (GUI) to enable a user to the TLEs by drawing a box around a block of data and specifying one or more lines within the box that are used to extract the one or more TLEs.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 is a flow diagram for one embodiment of generating TLEs;

FIG. 3 illustrates a screen shot for one embodiment of a TLE generation user interface;

FIG. 4 illustrates a screen shot for another embodiment of a TLE generation user interface; and

FIG. 5 illustrates a screen shot for yet another embodiment of a TLE generation user interface.

### DETAILED DESCRIPTION

A data extraction mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

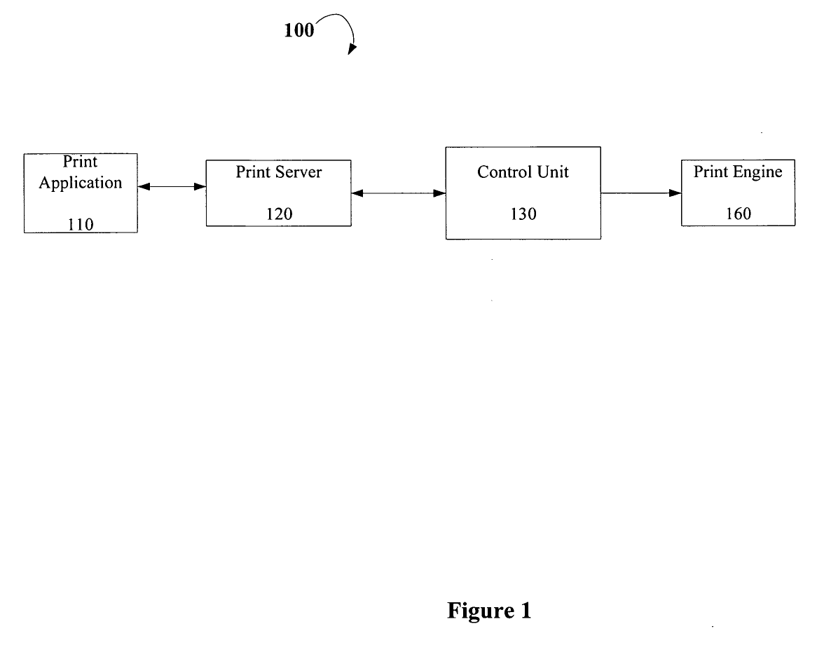

FIG. 1 illustrates one embodiment of an Advanced Function Presentation (AFP) printing system 100. Printing system 100 includes a print application 110, a server 120, a control unit 130 and a print engine 160. Print application 110 makes a request for the printing of a document. In one embodiment, print application 110 provides a Mixed Object Document Content Architecture (MO:DCA) data stream to print server 120.

In other embodiments print application 110 may also provide PostScript (P/S) and PDF files for printing. P/S and PDF files are printed by first passing them through a pre-processor (not shown), which creates resource separation and page independence so that the P/S or PDF file can be transformed into an AFP MO:DCA data stream prior to being passed to print server 120.

According to one embodiment, the AFP MO:DCA data streams are object-oriented streams including, among other things, data objects, page objects, and resource objects. In a further embodiment, AFP MO:DCA data streams include a Resource Environment Group (REG) that is specified at the beginning of the AFP document, before the first page. When the AFP MO:DCA data streams are processed by print server 120, the REG structure is encountered first and causes the server to download any of the identified resources that are not already present in the printer. This occurs before paper is moved for the first page of the job. When the pages that require the complex resources are eventually processed, no additional download time is incurred for these resources.

Print server 120 processes pages of output that mix all of the elements normally found in presentation documents, e.g., text in typographic fonts, electronic forms, graphics, image, lines, boxes, and bar codes. The AFP MO:DCA data stream is composed of architected, structured fields that describe each of these elements.

In one embodiment, print server 120 communicates with control unit 130 via an Intelligent Printer Data Stream (IPDS). The IPDS data stream is similar to the AFP data steam, but is built specific to the destination printer in order to integrate with each printer's specific capabilities and command set, and to facilitate the interactive dialog between the print server 120 and the printer. The IPDS data stream may be built dynamically at presentation time, e.g., on-the-fly in real time. Thus, the IPDS data stream is provided according to a device-dependent bi-directional command/data stream.

According to one embodiment, control unit 130 process and renders objects received from print server and provides sheet maps for printing to print engine 160. Objects are captured and stored in the printer capture storage 180.

In one embodiment, a user of printing system 100 may generate TLEs at print application 110. Particularly, application 110 provides a user interface that enables a process of defining a TLE that describes the location of data within a defined area of data. In such an embodiment, a TLE may be defined within the intermediate or last lines of the area.

For exemplary purposes, the TLE definition process will be described with references to a United States (US) address block. However, the process may be implemented to define TLEs in any data mining application where text is in a variable location within a specific area of a page. For instance, a US address block typically includes between 3 and 5 lines of data. The positions of the lines may vary in different statements but the address block usually appears within a defined area on a statement. Therefore, address data is not placed outside of this area, while no non-address is placed inside.

From such an address block, a user of print application 110 may wish to create zip code TLEs and optionally City/State TLEs. Further, a user may like to define TLEs for all intermediate lines. TLEs in an AFP document are typically created based on the position of transparent data (TRNs) on the page. For example, if the value of a social security number (SSN) is always found at a fixed position on a page, the TRN can be used to create an SSN TLE reliably.

However, such a process will not work for a TLE like zip code since the position of the zip code TRN can vary depending upon the number of address lines. Nonetheless, it can be guaranteed that the zip code will always appear on the last line or the penultimate line or so on, within an address block.

According to one embodiment, print application 110 facilitates the generation of a bounding box around a block of data and enables specification of one or more lines within the box that is used to extract one or more TLEs. For example, a bounding box may be generated around the address block of data and a particular line is specified to extract the zip code.

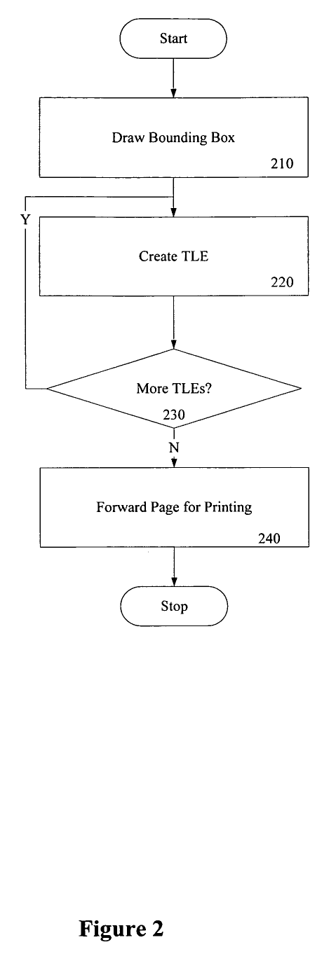

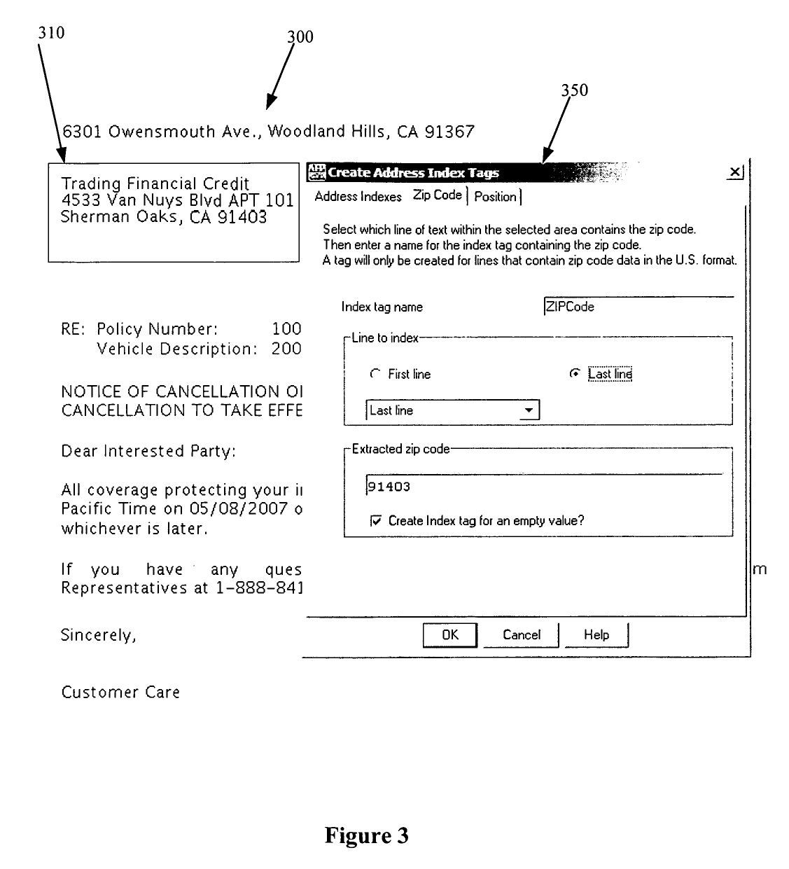

FIG. 2 is a flow diagram for one embodiment of generating TLEs. At processing block 210, a bounding box is drawn around a selected box of data. At processing block 220 a first TLE is generated. According to one embodiment, the first TLE is generated by selecting a specific line within the bounding box to be used as the TLE. FIG. 3 illustrates a screen shot for one embodiment of a TLE generation user interface 350 used to generate a bounding box 310 around a US address block within a page 300 and generating a first TLE.

Particularly, FIG. 3 shows a bounding box 310 drawn around the address block. Further, user interface 350 is used to select the last line within the box that is used to extract the zip code. In one embodiment, bounding box 310 is large enough to hold the maximum number of lines of an address block. For example, there is space in bounding box to hold five lines of data, although there are only three lines in the current address block.

Referring back to FIG. 2, it is determined whether a user wishes to generate a subsequent TLE, decision block 230. If there is another TLE to be generated, control is returned to processing block 220 where another TLE is generated. However, if there is no desire to generate another TLE, the page (along with TLE) is forwarded for printing at print engine 160 via print server 120 and control unit 130, processing block 240.

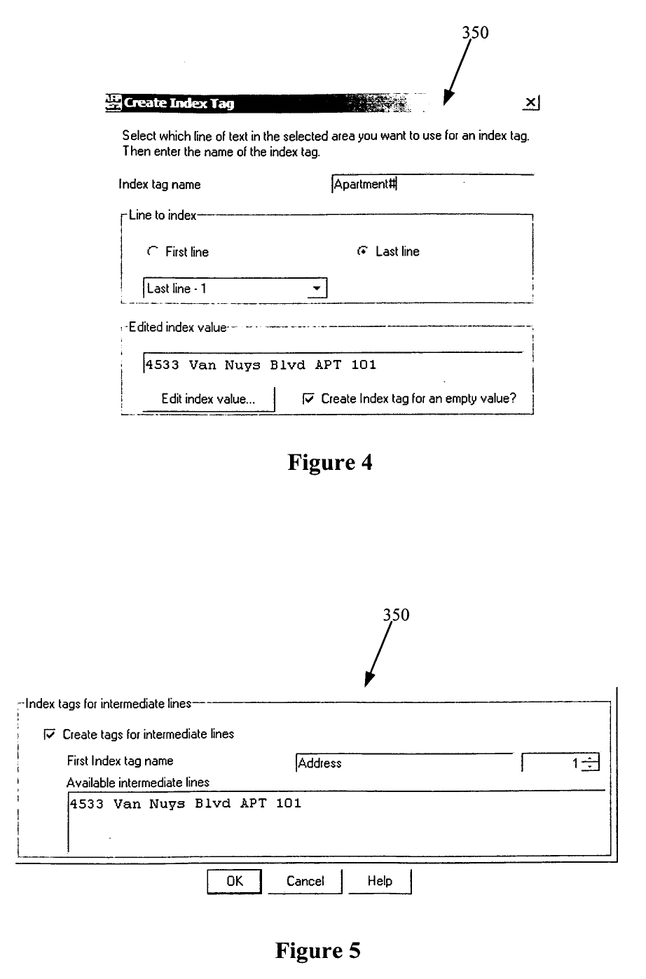

FIG. 4 illustrates a screen shot for one embodiment of user interface 350 used to generate a second TLE from the address block within bounding box 310. As shown, a similar approach is used to create City/State, or any other TLEs. If the TLE text appears on a different line than the last line, the line can be chosen with the last line as the reference point.

FIG. 5 illustrates a screen shot for yet another embodiment of user interface 350 generating intermediate TLEs. TLEs for the intermediate lines within an address block can be created by setting a first and last line. For example, the first line may include the name of the recipient and the last line may include city, state, zip code. Thus, each intermediate line is extracted and placed in a TLE called Address n, where n is between 1 and the number of intermediate lines in the current address block.

The above-described data extraction mechanism provides a way to clearly define the location of the data. As a result, there is no ambiguity in the definition, resulting in fewer errors than would occur in existing methods.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A method comprising generating one or more Tag Logical Elements (TLEs) in a variable location within a page of an Advanced Function Presentation (AFP) document.

2. The method of claim 1 wherein the generating comprises:
drawing a box around a block of data; and
specifying one or more lines within the box that are used to extract the one or more TLEs.

3. The method of claim 2 further comprising generating a first TLE corresponding to a first line of data within the box.

4. The method of claim 3 further comprising:
determining if an additional TLE is to be generated; and
generating a second TLE corresponding to a second line of data within the box if it is determined that an additional TLE is to be generated.

5. The method of claim 4 further comprising forwarding the AFP document and the one or more TLEs for print processing if it is determined that no additional TLE is to be generated.

6. The method of claim 2 wherein the box is drawn sufficiently large to hold a maximum number of lines of the block of data.

7. The method of claim 2 wherein the block of data is an address block.

8. The method of claim 7 wherein the first TLE is a zip code TLE and the second TLE is a city/state TLE.

9. A printing system comprising:
a print application to enable a user generate one or more Tag Logical Elements (TLEs) in a variable location within a page of an Advanced Function Presentation (AFP) document.

10. The printing system of claim 9 wherein the print application includes a graphical user interface (GUI) that enables a user to generate the TLEs by drawing a box around a block of data and specifying one or more lines within the box that are used to extract the one or more TLEs.

11. The printing system of claim 10 wherein the GUI enables the user to select a first line of data within the box to generate a first TLE.

12. The printing system of claim 11 wherein the GUI enables the user to select a second line of data within the box to generate a second TLE if the user chooses to generate an additional TLE.

13. The printing system of claim 9 further comprising a print server to receive print request from the print application.

14. The printing system of claim 13 further comprising a control unit to process and render objects received from print server.

15. The printing system of claim 14 further comprising a print engine to receive sheet maps for printing from the control unit.

16. A print application comprising:
a graphical user interface (GUI) to enable a user to generate Tag Logical Elements (TLEs) in a variable location within a page of an Advanced Function Presentation (AFP) document by drawing a box around a block of data and specifying one or more lines within the box that are used to extract the one or more TLEs.

17. The print application of claim 16 wherein the GUI enables the user to select a first line of data within the box to generate a first TLE.

18. The print application of claim 17 wherein the GUI enables the user to select a second line of data within the box to generate a second TLE if the user chooses to generate an additional TLE.

19. The print application of claim 17 wherein the box is drawn sufficiently large to hold a maximum number of lines of the block of data.

20. The print application of claim 16 further comprising a mechanism to forward the AFP document and the one or more TLEs for print processing once the user has completed generating TLEs.
